(19) United States
(12) Patent Application Publication
(10) Pub. No.: US 2024/0116118 A1
(43) Pub. Date: Apr. 11, 2024

(54) CUTTING TOOL WITH ADDITIONAL SHAFT-SIDE SECONDARY CUTTING TOOLS

(71) Applicant: Heule Werkzeug AG, Balgach (CH)

(72) Inventor: Roman Faessler, Marbach (CH)

(21) Appl. No.: 18/475,983

(22) Filed: Sep. 27, 2023

(30) Foreign Application Priority Data
Oct. 5, 2022 (EP) EP 22 19 98 88.3

(51) Int. Cl. B23B 51/08; B23B 51/00; B23B 51/02; B23B 51/10

(52) U.S. Cl. CPC B23B 51/08; B23B 51/0003; B23B 51/02; B23B 51/102; B23B 51/105; B23B 2220/08

(57) ABSTRACT

Cutting tool, which is driven with its shaft so that it rotates about its longitudinal axis or in a pushing and pulling manner, and wherein further shaft-side secondary cutting tools are fastened to the shaft, wherein the secondary cutting tools are fastened to the shaft of the cutting tool in an exchangeable manner.

The object of the invention is a cutting tool with additional shaft-side secondary cutting tools according to the preamble of claim 1.

From DE 10 2015 005 250 A1, of the same applicant, it is known to attach to the shaft of a cutting tool an additional secondary cutting tool, which is directed radially and, upon rotation of the primary cutting tool, develops a cutting action in the circumferential direction of the primary cutting tool. This publication describes a drilling-chamfering combined tool in which an additional chip-removing secondary tool is non-detachably and non-replaceably attached to the shaft of a rotationally driven primary chip-removing tool.

A similar prior art results from DE 92 07 000 U1, which also shows a deburring tool with an additional secondary deburring tool on the shaft side. Here, too, the additional deburring tool is located directly in a non-replaceable manner in the shaft-side working region of the primary tool.

The disadvantage of both designs is that additional specific installation measures must be taken in the cylindrical shaft of the primary cutting tool in order to precisely integrate the secondary cutting tool. These additional measures must be adapted to the specific type of secondary cutting tool, which prevents different secondary cutting tools from being used on the same primary cutting tool.

It is also not possible to replace the secondary cutting tool. In case of wear of the secondary cutting tool, a complete replacement of the primary tool together with the secondary cutting tool is necessary, which is associated with high costs.

With such a prior art solution, it is a disadvantage that a secondary cutting tool which is arranged in the working region of the primary cutting cannot be replaced and that a rotationally driven primary cutting tool cannot be subsequently retrofitted with additional radial cutting tools, which is however desirable in many cases.

There is a need for a rotationally driven, cutting primary tool, in particular a deburring tool, e.g. a drill, a milling cutter or the like, to be able to be retrofitted with additional cutting tools on the one hand and on the other hand to be miniaturized in such a way that the cylindrical working region of the deburring tool is not decisively weakened or changed by the additional receiving of a cutting tool.

The object of the invention is therefore to provide an operationally reliable attachment of a secondary cutting tool to the shaft of a primary cutting tool.

The object is achieved by the technical features of claim 1.

In a preferred embodiment, it is provided that different secondary cutting tools are to be interchangeably arranged on the shaft of a primary cutting tool depending on the cutting task.

It is preferred if each secondary cutting tool is accommodated in a cassette-like receiving housing, which is fastened in a recessed pocket-shaped receiving opening in the shaft or in the helix of a cutting tool.

The preferred embodiment thus relates to secondary cutting tools which are replaceably secured to the shaft and/or in the chip-removing working region of the cutting tool.

Accordingly, a preferred feature of the invention is that in the shaft of the rotationally driven primary cutting tool at least on one side at least one recessed receiving opening is arranged, which is open in the radial direction, in which a respective receiving housing for receiving a secondary cutting tool is detachably inserted and is replaceably anchored there.

It is preferred if the location of the arrangement of the at least one shaft-side receiving opening is in the working region of the primary cutting tool.

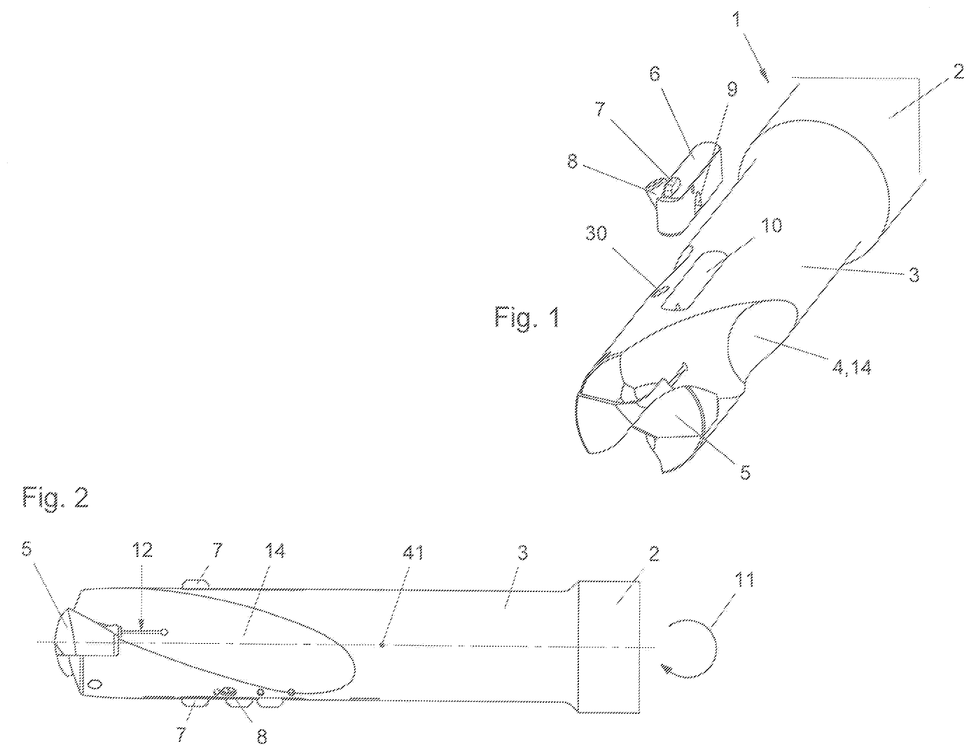

In a further preferred embodiment, it is provided that if the primary cutting tool is a drill, the one or more cassette-like secondary cutting tools are arranged in the region between the drilling helixes. This is shown in FIG. 1 of the application. This offers the advantage that the deburring of the top side of the workpiece already takes place during the drilling process, and thus the drill length can be decisively shortened. Otherwise the length behind the helical end must correspond to the thickness of the workpiece in order to apply the rear-side deburring.

The term “working region” is used in a preferred embodiment in such a way that the at least one receiving opening in the primary cutting tool according to the invention for receiving the receiving housing acting in the radial direction is preferably arranged in the shaft region between the clamped tool shaft and the chip removal region of the primary cutting tool. A location is therefore preferred, which is above the chip removal shaft region and below the clamped shaft region of the primary cutting tool.

If—in the axial downward direction—there is still space in the clamped shaft region of the primary cutting tool for one or more pocket-shaped radially outwardly open receiving openings, these receiving openings can also be arranged in this—normally round-cylindrical—shaft region.

The introduction of such pocket-shaped receiving openings in a primary cutting tool can be carried out in various ways. As a rule, the rotary-driven, round-cylindrical cutting tool is made of tool steel.

A high-speed steel is a high-alloy tool steel used primarily as a cutting material, i.e. for milling tools, drills, turning tools and broaches. The designation refers to the cutting speeds, which are three to four times higher than those of ordinary tool steel. Whereas ordinary tool steel already loses its hardness at around 200° C., high-speed steel retains its hardness up to around 600° C. The common abbreviations begin with HSS or HS, derived from the English High Speed Steel. German designations are high speed steel, (high performance) high speed steel, high performance high speed steel and high performance cutting steel.

The introduction of one or more pocket-shaped receiving openings in the shaft of such a primary cutting tool can be performed by spark erosion, laser treatment or the like. In the case of spark erosion, the electrode tool is brought to within 0.004 to 0.5 mm of the workpiece. At the right moment, the flashover of sparks is brought about by increasing the applied voltage. The sparks cause the material to melt and vaporize in a punctiform manner. The removal result is influenced by intensity, frequency, duration, length, gap width and polarity of the discharges. The tool is moved with the help of a CNC control. Complex geometric shapes can be produced. The formation of the one or more shaft-side receiving openings can also preferably be carried out before any hardening treatment of the cutting tool, because the formation of the receiving opening(s) can then be carried out in the softer, still unhardened steel material.

Another preferred manufacturing method is the 3D laser melting process, in which the cutting tool is manufactured layer by layer in an additive melting process. In such a process, the shaft-side radially recessed receiving openings can be provided from the outset without the need for subsequent machining for producing the pocket-shaped receiving openings.

The laser melting process may require machining or forming work in a second step due to the fastening thread.

In the case of primary cutting tools, the use of replaceable cutting inserts, which are preferably made of carbide, is known. In such a case, it is sufficient to manufacture the shaft from an ordinary tool steel in which the formation of the one or more pocket-shaped receiving openings is particularly simple.

If more than one receiving opening is to be provided in the shaft region of the primary cutting tool, then the receiving openings may be evenly distributed on a single circumferential line on the circumference of the shaft.

In another embodiment, the receiving openings distributed on the circumference may also be arranged offset from one another in the axial direction of the shaft. They are then arranged in the shaft on different circumferential lines that are axially spaced apart from one another.

In a first preferred embodiment, the term “receiving opening pointing in the radial direction” means that a normal to the bottom region of the pocket-shaped receiving opening is directed in an exactly radial direction with respect to the longitudinal axis of the shaft. It is therefore perpendicular to the shaft longitudinal axis and is directed exactly in the radial direction.

However, the invention is not limited to this. In another preferred embodiment, it may be provided that the normal to the bottom region of the tool-side receiving opening is at an angle to the radial of the longitudinal axis of the shaft. This means that the pocket-shaped receiving housings inserted in the one or more receiving openings are directed obliquely radially outward when the cutting tools is inserted.

The provided technical teaching results in the advantage that the shaft region of a rotationally driven primary cutting tool need only be modified in such a way that at least on one side, but preferably on opposite sides, a respective pocket-shaped receiving opening is created, into which a receiving housing for holding a secondary cutting tool can be detachably inserted and anchored.

The receiving housing for the secondary cutting tool is preferably cassette-shaped, which means that it is a holding housing or a holder in which one or more secondary cutting tools are accommodated. These can also be interchangeably arranged. The receiving housing is inserted interchangeably into the shaft-side pocket-shaped receiving opening of the primary cutting tool and anchored positively and non-positively in the shaft-side receiving opening.

In addition to the arrangement of a single cassette-like receiving housing in the shaft of the primary cutting tool, a plurality of receiving openings evenly distributed on the circumference may also be arranged for holding a plurality of receiving housings with cutting tools integrated therein.

When in the following description the term “receiving housing” is used, this is to be understood in general terms. It is also possible to use the term “cassette” or “holding housing” or “holder” for such a receiving housing provided with cutting tools mounted therein.

The term “cutting tool”, which can be arranged in the receiving housing, encompasses various types of secondary cutting tools, namely, in particular, a deburring tool, as can be seen from the above-mentioned two publications of the same applicant, but also a countersinking tool or a honing tool or a boring tool or a grooving tool.

All of the aforementioned secondary cutting tools are characterized in that they perform chip-removing work, such as on a bore edge, during a rotation of the tool holder of the primary cutting tool in its circumferential direction, preferably the bore having been made by the primary cutting tool.

Accordingly, the type and shape of the secondary cutting tool are not important. This tool may have one or more cutting edges, and there may also be several tool blades or cutting blades.

Accordingly, the particular advantage of the technical teaching of the invention lies in the fact that in the shaft of a primary cutting tool only one or multiple pocket-shaped receiving openings are provided in the shaft of a primary cutting tool for the positive and non-positive, exchangeable reception of secondary cutting tools mounted in cassettes. This means that the secondary cutting tools are easily exchangeable and can be adapted to the application of the primary cutting tool from case to case and are easily exchangeable in case of wear.

The rotary-driven primary cutting tool can perform different tasks, for example it can carry a chip-removing drill tip on its front side, which can also be replaceable if necessary.

Likewise, it may be provided that a milling tool, a countersinking tool or a honing tool is arranged instead of the drill tip. The invention is not limited to this primary tool, which is rotationally driven, being a chip removing tool.

In another embodiment it is possible to omit the chip-removing feature of the primary tool. For this reason, the primary tool is also referred to as a “tool holder”, so that in this embodiment there is only a cylindrical shaft in which the one or more pocket-shaped receiving openings according to the invention are arranged as a holder for the one or more cutting tools.

In addition to the rotary drive of the primary tool, there is of course also the possibility that instead of the rotary drive, a push drive directed in the axial longitudinal direction is used. The tool holder with the shaft-side secondary cutting tools is then only pushed and pulled in the longitudinal direction. The rotary drive then takes place in circumferential direction only in indexing steps, as can be seen from an older patent of the same applicant. During this rotary drive, which takes place in indexing steps, there is no cutting action of the cutting tools. Consequently, the radially cutting tools in the secondary cutting tool perform a pushing and pulling cutting movement parallel to the longitudinal axis of the primary tool and machine a bore edge or a groove in an object not by turning but in bursts in the push and pull direction.

Accordingly, a preferred embodiment is directed to the interchangeable receiving of a cassette-shaped receiving housing in the cylindrical working region of a generic, rotationally and/or longitudinally oscillantingly driven primary tool.

In a first preferred embodiment, it is provided that the cassette-shaped receiving housing is designed as a tool holder or as a holding housing for one or more cutting or deburring blades, wherein in a first preferred embodiment, the fastening of this receiving housing in the receiving opening with an adapted shape, is performed by means of a V-shaped screw fastening.

The term “V-shaped screw fastening” is understood to mean that an oblique, outwardly open fastening recess is arranged at least on one side of the cassette-shaped receiving housing, and that the bore for receiving the fastening element is arranged in the cylindrical shaft region of the primary tool. Therefore, this first type of fastening is characterized in that the fastening bore arranged in the working region of the rotationally driven tool intersects at least one side surface of the receiving housing and in this side surface an associated fastening recess is arranged, in which the bolt-shaped end of the fastening element engages and tightens the receiving housing against the pocket-shaped surfaces of the receiving opening.

In a first embodiment, it is provided that the fastening element is a grub screw and that therefore the screw bolt of the grub screw engages in an associated adapted fastening recess arranged on the side surface of the receiving housing, wherein it is preferred that two opposite fastening recesses are arranged in respective opposite side surfaces of the receiving housing to enable left-hand or right-hand fastening of such receiving housings with cutting tools arranged therein.

In another embodiment, it may also be provided that more than one fastening bore is present, wherein the fastening bores may also be arranged, for example, distributed at a mutual distance in the axial longitudinal direction of the cassette-shaped receiving housing, in particular when larger receiving housings are to be held.

In a third embodiment, it may be provided that instead of arranging the fastening bore on at least one respective side surface of the receiving housing, a front fastening of the receiving housing may also be provided instead, there being various possibilities for this front fastening.

In a first embodiment, it may be provided that such a fastening bore is arranged only on one end face and that on the opposite end face of the receiving housing an associated projection or projecting ridge or other locking means is arranged which engages in an associated groove on the end face of the pocket-shaped receiving opening in the working region of the rotationally driven tool. Thus, a single end-face fastening screw would be sufficient to effectively fix the receiving housing according to the invention in the pocket-shaped receiving opening in the rotationally driven primary tool.

In another embodiment, it may be provided that a spring-loaded snap-in connection is present between the cassette-shaped receiving housing and the pocket-shaped receiving opening. Various embodiments are provided in this regard. A common feature of all embodiments is that the positive engagement connection arranged on one or both sides is designed as a spring-loaded snap-in connection. Such a snap-in connection may consist of a spring-loaded projection or pin which engages in an associated groove on the opposite part. If such a spring-loaded snap-in connection is arranged only on one side, e.g. the one end face of the receiving housing, the opposite side can be secured with a screw fastening.

However, it is also possible to arrange spring-loaded snap-in means on both sides of the receiving housing and to dispense with a screw fastening or to use the screw fastening only as an additional position securing means.

In another embodiment of the invention, it can be provided that instead of the projection arranged on one side, two screw elements can now be arranged on the front side at a mutual distance and opposite each other, the heads of which are designed in such a way that they cooperate with associated slopes of the receiving housing and thus hold down and positively fix the receiving housing in the receiving opening on the tool side.

In a preferred embodiment, it has been described above that the fastening element is formed as a cylindrical grub screw. Such a grub screw does not have a fastening head with an enlarged diameter and therefore has the advantage that it can be arranged recessed in the fastening bore on the tool side.

In another embodiment, the fastening element may be designed either as a tapered screw with a tapered head of increased diameter or as a transverse clamping pin which is not screwed into a bore but is driven into the receiving bore and which, due to its spreading effect, also ensures a holding-down action on the receiving housing in the receiving opening on the tool side.

In another embodiment, other fastening elements may be used instead of the cylindrical grub screw, in particular a countersunk head screw, the tapered head of which is designed to hold the receiving housing down in the receiving opening on the tool side and to fasten it positively.

In a third embodiment, it may be provided that the fastening element is designed as a cylinder-head screw with a cylinder head of increased diameter, which is recessed in the working region of the rotationally driven tool via inclined bores.

It is therefore not necessary that the bore axes for the fastening elements are perpendicular to the direction of rotation and longitudinal axis of the rotationally driven primary tool; in another embodiment it can also be provided that these bore axes are formed obliquely, namely form an angle to the longitudinal axis.

By the use of a fastening element described in multiple embodiments in an unilaterally open fastening recess on the side or end surface of the pocket-shaped receiving housing, the further advantage is achieved that not only a positive connection is made between the walls of the receiving housing and the associated walls of the receiving opening in the working region of the rotationally driven tool, but also a frictional clamping is effected, because due to the action of the forces from the fastening element a holding-down clamping action is effected on the cassette-shaped receiving housing, so that the latter is not only positively received in the receiving opening of the primary tool, but is also force-fittingly clamped with a clamping force provided by the fastening element, which can also be adjusted and controlled. Thus the high centrifugal forces acting on the secondary cutting tool can be well controlled.

All embodiments have in common that it is possible at any time to replace the receiving housing with the one or more cutting units arranged therein, which is superior to the prior art because the primary tool does not have to be replaced when only the cutting tool in the secondary cutting tool is worn.

Since high centrifugal forces act on the cassette-shaped receiving housing of the secondary cutting tool during the rotary drive of the primary cutting tool, in another embodiment undercuts can be arranged in the shaft-side pocket-shaped receiving opening, in which undercuts the cassette-shaped receiving housing engages with associated projections and is thus secured against the effects of centrifugal forces.

In a kinematic reversal of this design, suitable projections can be arranged in the wall region of the shaft-side receiving opening, which projections cooperate with associated grooves in the cassette-shaped housing. In both cases, the centrifugal forces are not absorbed by the fastening elements, but by the form-fitting connections between the cassette-type housing and the shaft-side pocket-shaped housing opening. The fastening elements then serve only to secure the position.

Accordingly, the positive connection between the cassette-like receiving housing and the pocket-shaped receiving opening can be designed as a snap-in or clamping or wedge or screw connection. Any combination of the previously mentioned connecting or locking means is also possible.

The subject matter of the present invention results not only from the subject matter of the individual claims, but also from the combination of the individual claims with each other.

All the data and features disclosed in the documents, including the abstract, in particular the spatial configuration shown in the drawings, could be claimed as essential to the invention, insofar as they are new, either individually or in combination, compared to the prior art. The use of the terms “essential” or “according to the invention” or “essential to the invention” is subjective and does not imply that the features thus designated must necessarily be part of one or more patent claims.

In the following, the invention will be explained in more detail by means of drawings merely illustrating one embodiment. Here, further features and advantages of the invention essential to the invention are apparent from the drawings and their description.

In particular:

FIG. 1 shows a perspective front view of a tool holder with an exemplary drill tip attached.

FIG. 2 shows the side view of the arrangement according to FIG. 1.

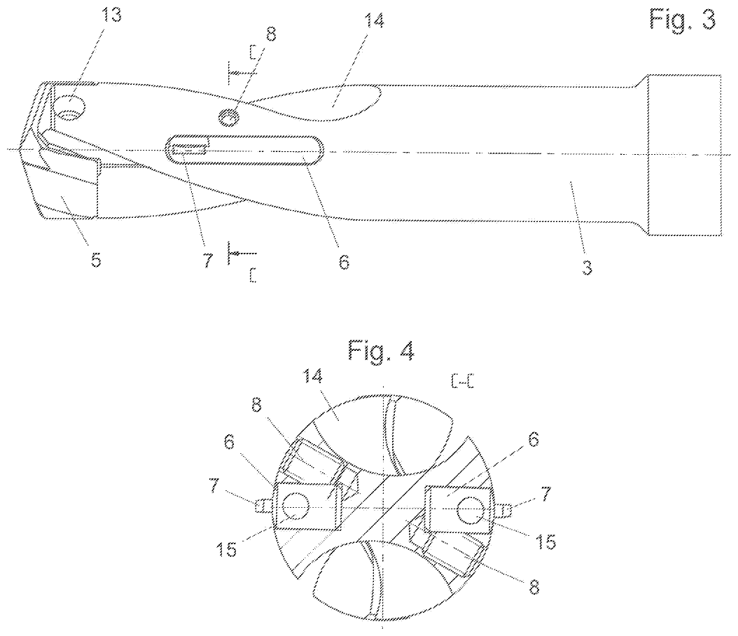

FIG. 3 shows the 90° rotated side view of FIG. 1

FIG. 4 shows a section along line C-C in FIG. 3.

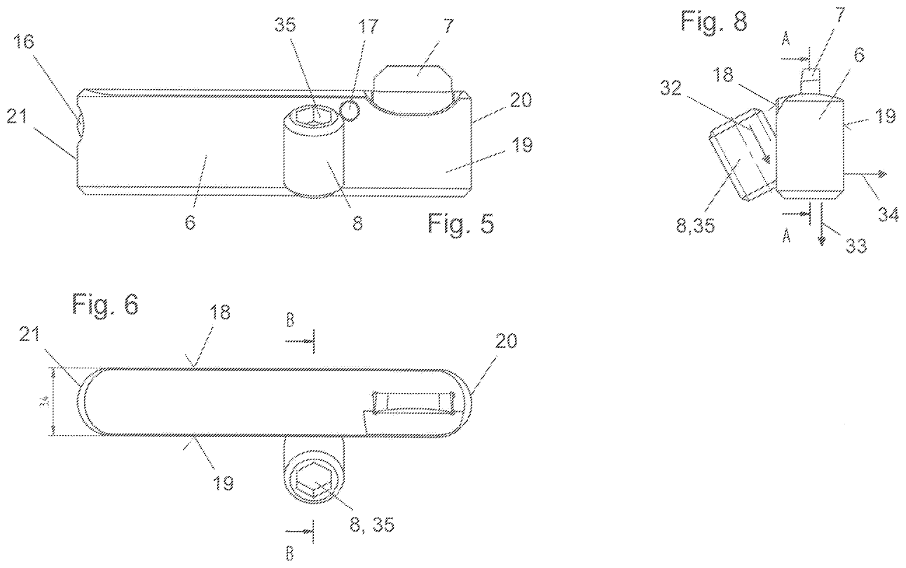

FIG. 5 shows the side view of the receiving housing.

FIG. 6 shows the 90° rotated view of FIG. 5.

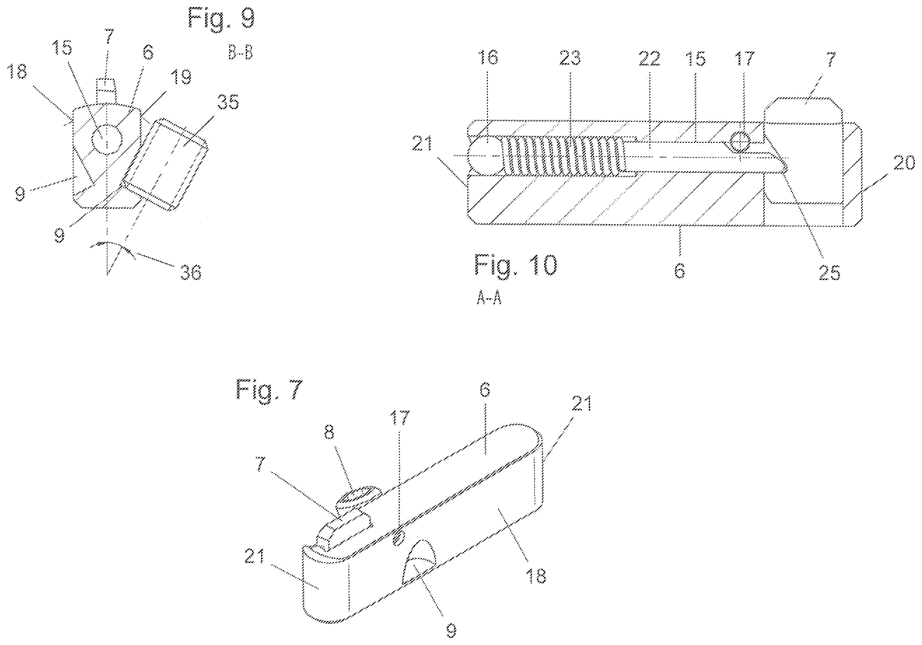

FIG. 7 shows the perspective view of the receiving housing according to FIGS. 5 and 6.

FIG. 8 shows a front view of the receiving housing.

FIG. 9 shows a section along line B-B in FIG. 6.

FIG. 10 shows a section along line A-A in FIG. 8.

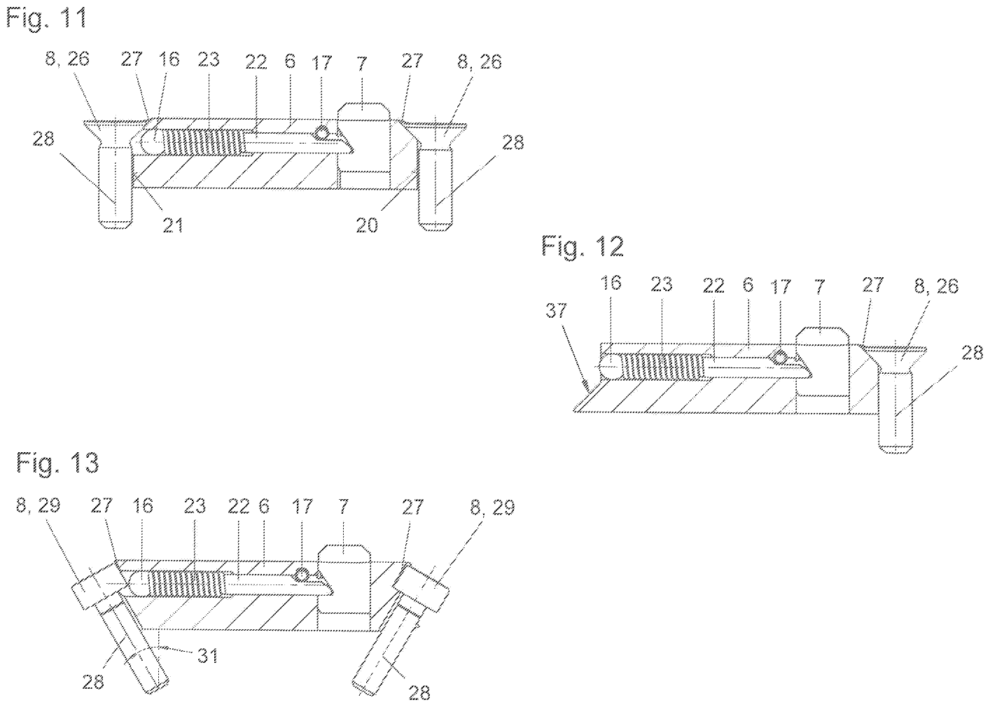

FIG. 11 shows a further embodiment for the fixation of a receiving housing in the receiving opening of a rotationally driven tool.

FIG. 12 shows a modified embodiment compared to FIG. 11 with only a screw fastening on one side.

FIG. 13 shows a modified embodiment compared to FIGS. 11 and 12, with a receiving housing fixed by means of oblique bores.

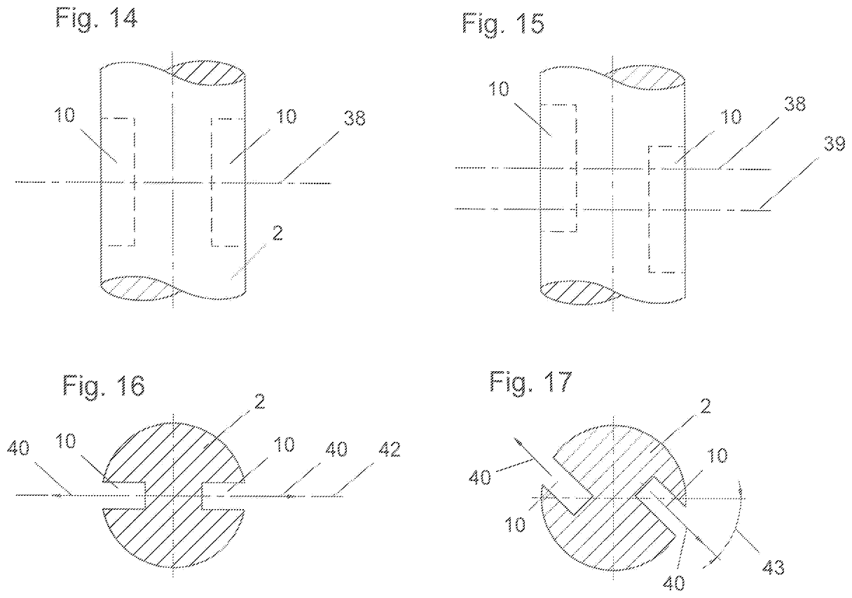

FIG. 14 shows a schematic view of the shaft-side arrangement of the receiving housing on a circumferential line

FIG. 15 schematizes a modification according to FIG. 14

FIG. 16 schematizes a section through a shaft with representation of the direction of action of the secondary cutting tools in a first embodiment

FIG. 17 shows a variation of FIG. 16.

FIG. 1 shows in general a tool holder 1 which, in an exemplary embodiment, carries only in its working region 3 a cutting tool, namely an interchangeable drill bit 5. The tool holder 1 was also referred to synonymously in the general description part as the primary cutting tool.

However, the invention does not rely on the cutting properties of a primary cutting tool, and for this reason, in the following drawing description section, the more general term “tool holder” has been chosen. When in the claims, with respect to the shaft of the primary cutting tool, the reference sign 2 is used for the shaft and at the same time the reference sign 3 is used for the working region of the cutting tool, this means that the place where the shaft-side receiving housing 6 is arranged may be both in the upper shaft 2 (below its clamping region) as well as in or at the working region 3.

The tool holder 1 generally consists of a cylindrical or polygonal shaft 2 which is rotationally driven about its longitudinal axis 41 in the direction of rotation 11 in any desired manner.

In the general description, it was also indicated that the cutting tool, namely the drill tip 5 referred to herein, can also be completely omitted because the cutting tool 4, which is located in the working region 3, can also be completely omitted. Thus, it may be that in an extended embodiment the cutting tool 4 is completely omitted in the working region of the rotationally driven tool holder 1 and that only a holder for the receiving housing 6 according to the invention is provided in a neutral tool holder 1, in which the cutting tools of the secondary cutting tool according to the invention, preferably the deburring blades 7 shown there, are arranged.

Accordingly, in the embodiment example shown according to FIGS. 1 to 4, with respect to the central longitudinal axis 41 of the tool holder 1 in the working region 3, namely in the region of the drill helix, elongated—preferably unilaterally open pocket-shaped—receiving openings 10 are arranged recessed in the shaft on diametrically opposite sides of the tool holder 1, which openings serve to receive the receiving housing 6 according to the invention—preferably of cassette-shaped design—in a non-positive and positive manner.

In addition to the elongated shape of the receiving openings 10, there are of course also other shapes, for example round-cylindrical, polygonal or other shapes of—preferably pocket-shaped—receiving openings 10, which are of course adapted to the shaping of the—preferably cassette-shaped—receiving housing 6 to be received there in a clamping and form-fitting manner.

In the exemplary embodiment shown, two diametrically opposite receiving openings 10 are provided for receiving two diametrically opposite receiving housings 6, as can be seen from FIG. 4.

The invention is not limited to this. In another embodiment, it may be provided that only a single receiving opening 10, which is open outwardly in the radial direction, is arranged on the circumference in the working region 3 of the tool holder 1, and in other embodiments, it may be provided that a plurality of receiving openings 10 are arranged evenly distributed on the circumference in the working region 3 of the tool holder 1 and/or in the region of the shaft 2 below its clamping region.

In the exemplary embodiment shown, the tool 4 consists of a replaceably held drill tip 5, wherein the drill tip 5 is fixed with the aid of a clamping slot 12 and an associated fastening screw 13.

The exchangeable holding of such a drill tip 5 results in the further advantage that the drill tip can be exchanged in the case of wear or can also be replaced by other cutting tools, such as milling heads, reamers and similar cutting tools.

In the exemplary embodiment shown, the drill tip 5 also has chip guide steps 14 and in this case it is preferred if the shaft-side receiving openings 10 according to the invention are arranged outside the chip guide steps 14 and are recessed into the cylindrical working region 3 in the shaft 2 of the tool holder 1, so that the overall available cross-section in the working region 3 is not weakened.

From the point of view of the size ratio, it can also be said that, for example, with a drill diameter of the primary cutting tool of less than 12.6 mm, a unilaterally open—preferably pocket-shaped—receiving opening 10 and thus also the—preferably cassette-shaped—positively adapted receiving housing 6 has a dimension of about 30 mm in the longitudinal direction and a width of 3.5 mm with a depth of 5.5 mm.

In the case of drill diameters of more than 25 mm up to diameters of 35 mm, the preferred dimensions of the shaft-side receiving opening 10 and thus also those of the receiving housing 6 can be approximately smaller and equal to L=40 mm, B=5.5 mm and T=8.5 mm.

For drill diameters of more than 35 mm, the preferred dimensions of the shaft-side receiving opening 10, and thus also those approximately smaller of the receiving housing 6 can be L=45 mm, B=6.5 mm and T=10.0 mm.

It follows from the preferred dimensional data provided above that the shaft-side formation of the receiving openings 10 for receiving the only insignificantly smaller receiving housings 6 only slightly alters the load-bearing cross-section of the cutting tool in the working region 3, in particular of the drill, so that high cutting forces can nevertheless be transmitted to the primary cutting tool.

This also results in the fact that the cross-section of the pocket-shaped receiving openings and the shaft-side volume removed for this purpose, which must be recessed in the working region 3, is very small compared to the separate attachments of cutting tools previously mentioned in the prior art in a rotationally driven tool holder.

In the exemplary embodiment shown, a one-sided clamping and positive fastening of the receiving housing 6 in the tool-side receiving opening 10 is described, wherein the fastening element 8 in a first embodiment is preferably designed as a grub screw 35.

When the term “fastening element 8” is used, it refers to various fastening elements, such as the grub screw 35 shown in the exemplary embodiment of FIGS. 1 to 10, but the invention is not limited thereto.

The bolt-side end of the grub screw 35 engages in a lateral fastening recess 9 in the receiving housing 6, which is open on one side and is formed in one or both side surfaces 18, 19.

Each fastening recess 9 is open laterally downward and outward, whereby a clamping of the receiving housing 6 according to FIGS. 8 and 9 in the shaft-side receiving opening 10 is achieved. Accordingly, when the grub screw 35 according to FIG. 8 is screwed in in the direction of force 32, thus forming an angle 36 to the vertical, a frictional clamping of the receiving housing 6 in the shaft-side shape-adapted receiving opening 10, as shown in more detail in FIG. 8.

There it can be seen that the grub screw 35 exerts a downward directed force 32 on the receiving housing 6, which is thus pressed in the clamping direction 33 onto the bottom surface of the shaft-side receiving opening 10 and is positively fixed there. Due to the angle 36 used, however, this grub screw 35 also presses on one side of the side surface 18 of the receiving housing 6 and presses it with its opposite side surface 19 in the direction of arrow 34 against the opposite side wall in the receiving opening 10, so that a positive and non-positive fixing of the receiving housing 6 in the receiving opening 10 can be achieved with only one grub screw 35. The grub screw 35 is screwed into a fastening bore 30 in the shaft, which is directed obliquely to the longitudinal axis 41 and to the radial direction 42.

From FIG. 4 it can be seen that two receiving housings 6 equipped with deburring blades are fixed diametrically opposite each other in the previously described manner in the shaft 2, which is a particular advantage over the prior art because FIG. 4 also shows that only little volume in the shaft-side working region 3 of the tool holder 1 is necessary for the exchangeable fixing of the diametrically opposite receiving housings 6.

With the previously mentioned dimensions, it is sufficient, for example, to adjust the depth of the receiving opening 10, depending on the diameter of the shaft 2, 3, only in the range between 7 mm to a maximum of 16.5 mm, which shows that only a small volume of the tool holder 1 is consumed in the case of a recessed formation of the—preferably pocket-shaped—receiving openings 10 and thus, in particular, the working region 3 is only slightly weakened so that it can be subjected to high machining forces and high torques.

As an example of a deburring tool, the embodiment of FIGS. 5 to 10 may be provided, to which, however, the invention is not limited. As previously indicated in the general part, instead of a deburring tool with the deburring blades 7 indicated there, other chip-removing tools can also be arranged in the receiving housing 6, such as, for example, countersinking tools, boring tools, grooving tools or honing tools, not shown in further detail.

The deburring blades 7 shown here are therefore to be understood only by way of example, because they can be taken from older patents of the same applicant. The deburring blade 7 is held in a transverse bore in the receiving housing 6 as shown in FIGS. 7 and 10 so as to be displaceable in the radial direction under spring load and has a lateral control groove 25 in which the pin tip of a control pin 22 engages, which presses into the control groove 25 under preload by a compression spring 23, wherein the compression spring 23 is held to the rear in the longitudinal bore 15 by a locking ball 24. Accordingly, the entire adjustment mechanism is arranged in the longitudinal bore 15 in the—preferably cassette-shaped—receiving housing 6, and a retaining pin 17 serves to secure the position when the control pin 22 is displaced.

In another embodiment of the present invention, however, it can also be provided that instead of the one-sided or also two-sided fastening of the receiving housing 6 by means of associated grub screws 35, also a frontal fastening to the mutually opposite end faces 20, 21 of the receiving housing 6 is provided.

In this case, FIG. 11 shows a first embodiment in which it can be seen that the end-frontal fastening of the receiving housing 6 is provided by means of two mutually opposite countersunk head screws 26, which are screwed into parallel bore axes 28, whereby the respective head of the countersunk head screw rests against an associated chamfer 27 on the top of the receiving housing 6 and pulls it down to the bottom of the receiving opening 10 and fixes it there.

In another embodiment, it may also be provided that the countersunk head screws 26 are screwed in at an angle, which means that, in a variation of FIG. 11, it may be provided that the bore axes 28 form an angle 31 with respect to each other, as shown in the other embodiment of FIG. 13.

In a third embodiment, a one-sided fastening with only one single countersunk head screw 26 can also be provided, as shown in FIG. 12. There, on one end face 21 of the housing 6, a projection 37 is arranged, which engages in an associated recess or undercut, not shown in greater detail, on the end face of the receiving opening 10. On the opposite end face 20, there is either a single countersunk head screw 26 having a vertical bore axis 28 or a countersunk head screw with an inwardly and obliquely directed bore axis 28, as shown in FIG. 13.

Instead of the frontal fixing of the receiving housing 6 with projections 37 arranged there, which engage under grooves or undercuts, not shown in detail, on the end face of the receiving opening 10, such a type of fastening can also be provided on the longitudinal sides of the receiving housing 6 in the region of the side surfaces 18, 19.

In kinematic reversal, the projections 37 on the end face or the side surface 20, 21; 18, 19 can also be formed as undercuts that engage behind associated projections in the shaft-side receiving housing 6.

In addition to the one-sided or two-sided fastening with the aid of countersunk head screws 26, cylinder head screws 29 as shown in FIG. 13 can also be used, wherein these cylinder head screws 29 each bear with their heads of enlarged diameter against an associated chamfer 27 in the region of the end faces 20, 21 or side surfaces 18, 19 and thus likewise press the receiving housing 6 both in the downward direction in the direction of arrow 33 against the bottom of the receiving opening 10 and also exert an additional lateral biasing in an oblique direction on the side surfaces of the receiving opening 10, so that the receiving housing 6 is clamped in the receiving opening 10 in a force- and form-fitting manner.

Accordingly, the bore axes 28 of the cylinder head screws are each arranged in the region of fastening bores 30 in the working region 3 of the rotationally driven tool holder 1. These can be threaded bores, but can also be purely cylindrical, smooth bores if cylinder clamping pins are used instead of the fastening screws 26, 29, 35 described here.

FIG. 14 shows, in an exemplary embodiment, that the shaft-side receiving openings 10 are arranged on a common circumferential line 38.

FIG. 15 shows, in a variation, that the shaft-side receiving openings 10 have a mutual axial spacing and are thus arranged on different circumferential lines 38, 39 in the shaft 2, 3.

FIG. 16 shows that the working direction 40 of the receiving housings 6 inserted in the shaft-side receiving openings 10 and of the deburring blades 7 arranged there is directed in the radial direction 42. The deburring blades are thus pressed radially outward under spring load in the working direction 40.

FIG. 17 shows a modification of FIG. 16 from which it can be seen that the working direction 40′ can also be oblique at an angle 43 to the radial working direction 40 according to FIG. 16.

Accordingly, it is characteristic of the invention that an exchangeable receiving housing 6 with various fastening devices can be fitted in a positive and non-positive manner preferably in the shaft-side working region 3 on the circumference of a rotationally driven tool holder 1 and that in this receiving housing 6 any type of cutting tools are arranged.

### LIST OF REFERENCE NUMERALS

1 tool holder
2 shaft
3 working region
4 tool
5 drill tip
6 receiving housing
7 deburring blade
8 fastening element
9 fastening recesses
10 receiving opening
11 direction of rotation
12 clamping slot
13 fastening screw
14 chip guide steps
15 longitudinal bore
16 locking ball
17 retaining pin
18 side surface
19 side surface
20 end face
21 end face
22 control pin
23 compression spring
24 locking ball
25 control groove
26 countersunk head screw
27 chamfer
28 bore axis
29 cylinder head screw
30 fastening bore
31 angle
32 direction of force
33 clamping direction
34 arrow direction
35 grub screw
36 angle
37 projection
38 circumferential line
39 circumferential line
40 working direction (of 7); 40′
41 longitudinal axis (of 2 and 4)
42 radial direction
43 angle to 42

1. A cutting tool which is driven with its shaft in a rotating or pushing and pulling manner about its longitudinal axis, and wherein further shaft-side secondary cutting tools are fastened to the shaft, wherein the secondary cutting tools are fastened in an exchangeable manner to the shaft and/or in the chip-removing working region of the cutting tool.

2. The cutting tool according to claim 1, wherein one or more secondary cutting tools are arranged on the circumference of the shaft of the cutting tool.

3. The cutting tool according to claim 1, wherein each secondary cutting tool is received in a cassette-like receiving housing which is detachably arranged in a pocket-shaped recessed receiving opening in the shaft of the cutting tool.

4. The cutting tool according to claim 1, wherein the at least one shaft-side, unilaterally open receiving opening in the shaft of the cutting tool is aligned in a radial direction relative to the longitudinal axis of the shaft.

5. The cutting tool according to claim 1, wherein the at least one shaft-side, unilaterally open receiving opening in the shaft of the cutting tool is aligned at an angle to the radial direction to the longitudinal axis of the shaft.

6. The cutting tool according to claim 1, wherein the at least one shaft-side receiving opening is arranged in the working region or below the clamping region in the shaft of the cutting tool.

7. The cutting tool according to claim 1, wherein multiple secondary cutting tools are arranged evenly distributed on the circumference of the shaft of the cutting tool on a same circumferential line.

8. The cutting tool according to claim 1, wherein multiple secondary cutting tools are arranged uniformly distributed on the circumference of the shaft of the cutting tool on circumferential lines axially offset relative to one another.

9. The cutting tool according to claim 1, wherein the cutting tool is a drill or a milling cutter or a deburring tool or a turning chisel or a broaching tool.

10. The cutting tool according to claim 1, wherein secondary cutting tools are designed as a deburring tool or as a countersinking tool or as a honing tool or as a grooving tool.

11. The cutting tool according to claim 1, wherein chip-removing tools are missing at the tip of the tool.

12. The cutting tool according to claim 1, wherein the at least one cassette-shaped receiving housing for holding the at least one secondary cutting tool is interchangeably and positively fastened in the at least one associated shaft-side receiving opening of the cutting tool.

13. The cutting tool according to claim 1, wherein the fastening of the receiving housings in the shaft-side receiving openings is designed as a screw fastening.

14. The cutting tool according to claim 1, wherein two mutually opposite fastening recesses in the shaft of the cutting tool are provided on mutually opposite side surfaces of the receiving housing, in order to permit left-hand or right-hand fastening of receiving housings in the shaft-side receiving opening.

15. The cutting tool according to claim 13, wherein the screw fastening is formed by at least one grub screw which is screwed in a threaded bore in the shaft directed obliquely to the radial direction and engages with its end on the bolt side into a fastening recess on the side wall of the receiving housing directed obliquely outwards and open on one side.

16. The cutting tool according to claim 13, wherein the screw fastening is formed by two threaded screws each bearing against the end face of the receiving housing.

17. The cutting tool according to claim 13, wherein one side of the receiving housing is fixed in the pocket-shaped receiving opening by means of a positively fitting suspension connection.

18. The cutting tool according to claim 1, wherein the positive connection between the cassette-like receiving housing and the pocket-shaped receiving opening is designed as a snap-in or clamping or wedge or screw connection.
